(19) United States
(12) Patent Application Publication
(10) Pub. No.: US 2026/0138440 A1
(43) Pub. Date: May 21, 2026

(54) TOLERANT EXHAUST SYSTEM

(71) Applicant: FCA US LLC, Auburn Hills, MI (US)

(72) Inventors: Vikas Naresh Sanghavi, Auburn Hills, MI (US); Milind Shivaji Parab, Auburn Hills, MI (US); Meyyappan Valliappan, Auburn Hills, MI (US)

(21) Appl. No.: 18/950,557

(22) Filed: Nov. 18, 2024

(51) Int. Cl. B60K 13/04

(52) U.S. Cl. CPC B60K 13/04

(57) ABSTRACT

An exhaust system has an exhaust pipe that extends from an exhaust manifold. The exhaust pipe has a desired bend to position adjacent the occupant compartment. An exhaust flex coupling extends from the exhaust pipe. The flex coupling is deformable. A first hanger secures the exhaust pipe to a powertrain. The first hanger is detachable from the exhaust pipe or powertrain at a desired load during an impact event. A second hanger is secured to the exhaust system adjacent the flex coupling and to a vehicle frame. The second coupling maintains integrity during the impact event.

### FIELD

The present disclosure relates to automotive vehicles and, more particularly, to an exhaust system.

### BACKGROUND

This section provides background information related to the present disclosure which is not necessarily prior art.

In automotive vehicles, the exhaust system extends from the engine rearward towards the back of the vehicle. Thus, the exhaust necessitates that it is positioned underneath the vehicle. Various components are utilized to extend the exhaust from the engine to the rear of the vehicle. However, components such as the muffler, catalytic converter, pre catalytic convert must be strategically positioned in the exhaust system underneath the vehicle.

In the event of an impact on the vehicle, the exhaust system may shift underneath the vehicle. Sometimes the shift may contact the floor of the passenger compartment. Thus, this is not undesirable. Due to the fact that the exhaust is positioned underneath the vehicle, it is ordinarily positioned underneath the driver's side beneath the operational pedals. Accordingly, in current designs, the exhaust may contact the floor on the driver's side of the vehicle. Thus, designers strive to provide an exhaust system that bypasses contact with the driver's side floor.

Accordingly, the present disclosure provides an exhaust system that moves laterally if impacted to avoid the driver's side floor moving towards the drivetrain. The present disclosure provides an exhaust system that is balanced to meet exhaust gas back pressure requirements. The present design enables the exhaust system to typically be routed closer to the vehicle underbody.

### SUMMARY

This section provides a general summary of the disclosure, and is not a comprehensive disclosure of its full scope or all of its features.

According to a first aspect of the disclosure, a vehicle exhaust system comprises an exhaust pipe extending from an exhaust manifold. The exhaust pipe has desired bends to position it adjacent the occupant compartment. An exhaust flex coupling extends from the exhaust pipe. The flex coupling is deformable. A first hanger secures the exhaust pipe to a powertrain. The first hanger is detachable from the exhaust pipe or powertrain at a desired impact load during an impact event. A second hanger secures to the exhaust system adjacent the flex coupling and to a vehicle frame. The second hanger maintains integraty during the impact event. During the impact event, the flex coupling deforms providing lateral movement away from a load path during the impact event. The second hanger is welded or the like to the exhaust system. The exhaust flex coupling is secured with a second exhaust pipe exhausting to a muffler or the like. The exhaust pipe is positioned between a pre-converter and a main converter. The exhaust pipe is balanced to meet back pressure requirements. The exhaust pipe is devoid of deformation during the impact event.

According to a second aspect of the disclosure, a vehicle includes an exhaust system that comprises an exhaust pipe that extends from an exhaust manifold. The exhaust pipe has desired bends to position it adjacent the occupant compartment. An exhaust flex coupling extends from the exhaust pipe. The flex coupling is deformable. A first hanger secures the exhaust pipe to a powertrain. The first hanger is detachable from the exhaust pipe or powertrain at a desired impact load during an impact event. A second hanger is secured to the exhaust system adjacent the flex coupling and to a vehicle frame. The second coupling maintains integraty during the impact event. During the impact event, the flex coupling deforms to provide lateral movement away from a load path during the impact event. The second hanger is welded or the like to the exhaust system. The exhaust flex coupling is secured with a second exhaust pipe that exhausts to a muffler or the like. The exhaust pipe is positioned between a pre-converter and a main converter. The exhaust pipe is balanced to meet back pressure requirements. The exhaust pipe is devoid of deformation during the impact event.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an exhaust system on a vehicle.

FIG. 2 is a schematic view of the exhaust system of FIG. 1 in a top view.

FIG. 3 is a top perspective view of the exhaust system.

FIG. 4 is a side perspective view of the exhaust system.

FIG. 5 is a view like FIG. 2 after an impact event.

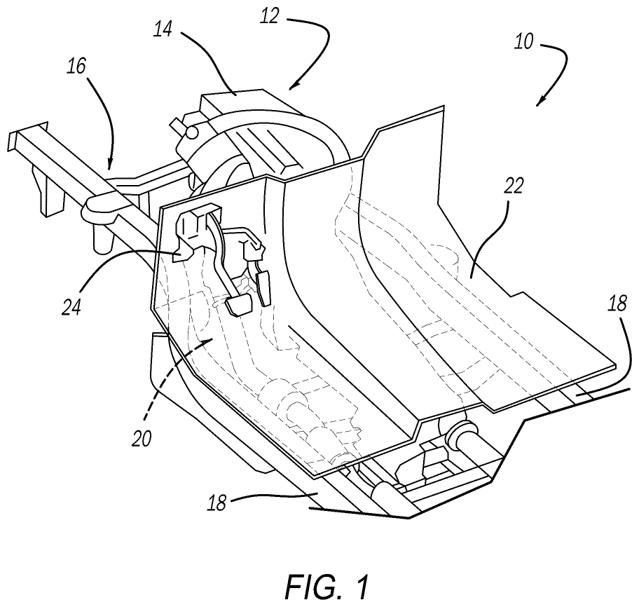

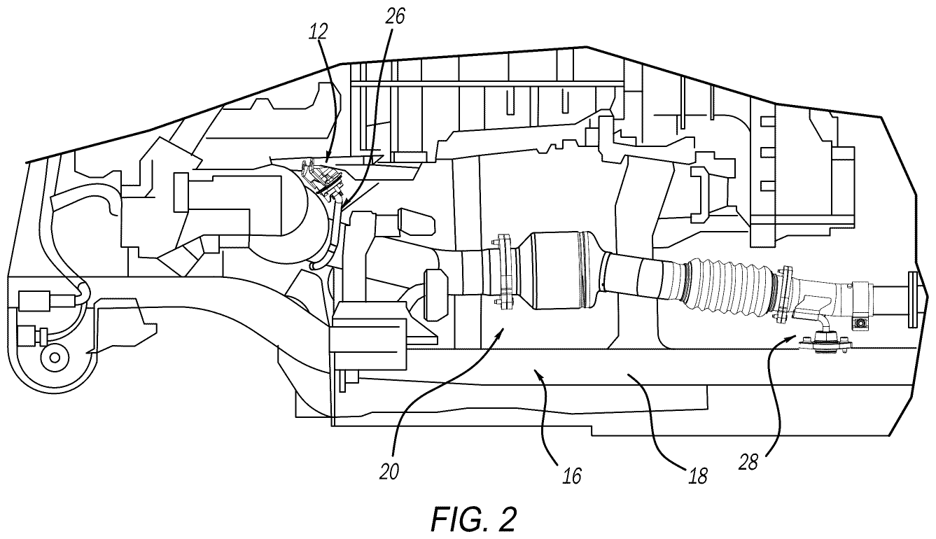

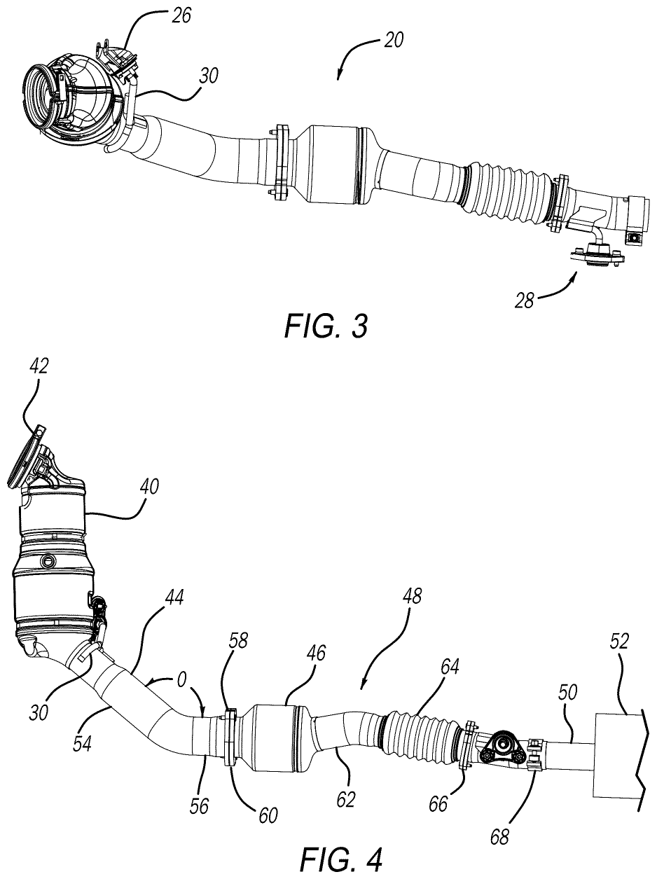

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle includes a drivetrain 12 which includes an internal combustion engine 14. The drivetrain 12 is supported by a frame 16. The frame 16 includes side beams 18. An exhaust system 20 is coupled with the internal combustion engine 14 and extends to the rear of the vehicle.

The exhaust system 20 is positioned underneath the floor 22 of the vehicle 10. Specifically, the exhaust system 20 runs underneath the driver side of the vehicle underneath the vehicle's pedals 24. The pedals 24 are, generally, an accelerator and a brake.

The exhaust system 20 is secured to the drivetrain by a first hanger 26 and to the frame beam 18 by a second hanger 28. The first hanger 26 generally has a U-shape connector 30 that partially surrounds a portion of the exhaust 20. The first hanger 26 is secured to the drivetrain 12, via bolts.

Generally, the U-shape member 30 is detachable from the exhaust system 20 or the powertrain 12 when a desired load is applied to it during an impact event. The second hanger 26 can be secured to the frame beam 18 by welding or the like. Also, the second hanger 26 is welded to the exhaust system 20. The second hanger 26 maintains integrity of the exhaust system 20 during the impact event.

The exhaust system 20 includes a pre-converter 40 that is coupled with a manifold 42 of the internal combustion engine 14. The pre-converter 40 has an exhaust pipe 44 extending from the pre-converter 40 and is coupled with a main converter 46 which, in turn, is coupled with a flex coupling 48. The flex coupling 48 is coupled with a second exhaust pipe 50 which, in turn, includes a muffler 52 and the remainder of the conventional exhaust system.

The first exhaust pipe 44 has a first portion 54 and a second portion 56, angled with respect to the first portion, to provides an overall angled L-shape. The angle between the first portion 54 and the second portion 50 is between ______ degrees and ______ degrees. This provides for the positioning of the exhaust system 20 close to the vehicle underbody. The second portion 56 includes a flange 58 to couple with a flange 60 of the converter 46.

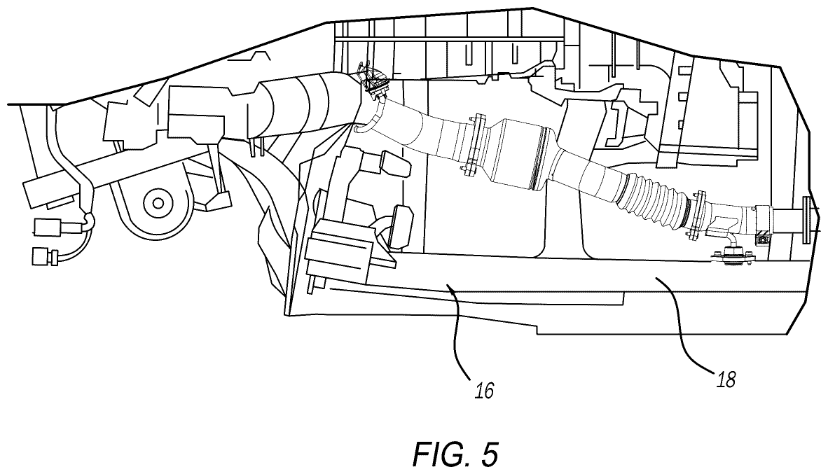

The main converter 46 includes the flex coupling 48 that extends from it. The flex coupling 48 includes a first portion 62 with a second corrugated pipe portion 64. The corrugated pipe portion 64 provides the flexing of the coupling 48 during an impact. The accordion like corrugation portion 64 collapses or moves to enable the entire exhaust system 20 between the two hangers to move laterally with respect to the longitudinal axis of the vehicle. This lateral movement reduces intrusion of the exhaust system 20 into the occupant compartment. The accordion portion 64 is adjacent to a flange 66 that is coupled to a second flange 68 of the second exhaust pipe 50 of the exhaust system 20. This, with the portions of the exhaust system 20 between the two hangers 26, 28 enables the first hanger to release at a desired load so that the exhaust system can move laterally underneath the underbody of the vehicle. Also, the second hanger 28 maintains the integrity of the exhaust system so that it remains in place. This is best illustrated in FIG. 5. Thus, the exhaust system 20 moves away from the pedals to reduce or prohibit the entrance of the exhaust system into the occupant compartment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An exhaust system comprising:
an exhaust pipe extending from an exhaust manifold, the exhaust pipe having a desired bend to position it adjacent the occupant compartment;
an exhaust flex coupling extending from the exhaust pipe, the flex coupling is deformable;
a first hanger for securing the exhaust pipe to a powertrain, the first hanger detachable from the exhaust pipe or powertrain at a desired load during an impact event;
a second hanger secured to the exhaust system adjacent the flex coupling and to a vehicle frame, the second coupling maintaining integrity during the impact event.

2. The exhaust system of claim 1, wherein during the impact event, the flex coupling deforms providing lateral movement away from a load path during the impact event.

3. The exhaust system of claim 1, wherein the second hanger is welded or the like to the exhaust system.

4. The exhaust system of claim 1, wherein the exhaust flex coupling secures with a second exhaust pipe exhausting to a muffler.

5. The exhaust system of claim 1, wherein the exhaust pipe is positioned between a pre-converter and a main converter.

6. The exhaust system of claim 1, wherein the exhaust pipe is balanced to meet back pressure requirements.

7. The exhaust system of claim 1, wherein the exhaust pipe is devoid of deformation during the crash event.

8. A vehicle including an exhaust system comprising:
an exhaust pipe extending from an exhaust manifold, the exhaust pipe having a desired bend to position it adjacent the occupant compartment;
an exhaust flex coupling extending from the exhaust pipe, the flex coupling is deformable;
a first hanger for securing the exhaust pipe to a powertrain, the first hanger detachable from the exhaust pipe or powertrain at a desired load during an impact event;
a second hanger secured to the exhaust system adjacent the flex coupling and to a vehicle frame, the second coupling maintaining integrity during the impact event.

9. The vehicle of claim 8, wherein during the impact event, the flex coupling deforms providing lateral movement away from a load path during the impact event.

10. The vehicle of claim 8, wherein the second hanger is welded or the like to the exhaust system.

11. The vehicle of claim 8, wherein the exhaust flex coupling secures with a second exhaust pipe exhausting to a muffler.

12. The vehicle of claim 8, wherein the exhaust pipe is positioned between a pre-converter and a main converter.

13. The vehicle of claim 8, wherein the exhaust pipe is balanced to meet back pressure requirements.

14. The vehicle of claim 8, wherein the exhaust pipe is devoid of deformation during the crash event.
